(19) United States
(12) Patent Application Publication
(10) Pub. No.: US 2023/0323727 A1
(43) Pub. Date: Oct. 12, 2023

(54) ASSEMBLY OF A VEHICLE WITH A CONTROL ELEMENT ARRANGED ON A VEHICLE DOOR

(71) Applicant: Brose Fahrzeugteile SE & Co. Kommanditgesellschaft, Bamberg, Bamberg (DE)

(72) Inventors: Markus ROSENTHAL, Bamberg (DE); Philipp KONARSKI, Hallstadt (DE)

(21) Appl. No.: 18/296,891

(22) Filed: Apr. 6, 2023

(30) Foreign Application Priority Data
Apr. 6, 2022 (DE) 10 2022 203 459.7

(51) Int. Cl. E05F 15/76; B60R 25/01; B60R 25/24; E05B 81/04; E05B 81/56; E05B 81/76; E05F 15/611

(52) U.S. Cl. CPC E05F 15/76; B60R 25/01; B60R 25/24; E05B 81/04; E05B 81/56; E05B 81/77; E05F 15/611; E05Y 2400/86; E05Y 2900/531

(57) ABSTRACT

An assembly of a vehicle comprises a vehicle door, a control element arranged on a door portion of the vehicle door, and a control device for controlling a closing function for closing the vehicle door and an opening function for opening the vehicle door. The control element comprises at least one first operating device for generating an operating signal on user operation at an outer portion and at least one second operating device for generating an operating signal on user operation at an inner portion. The control device is configured to trigger a closing function for closing the vehicle door with reference to an operating signal of the at least one first operating device and to trigger an opening function for opening the vehicle door with reference to an operating signal of the at least one second operating device.

### CROSS-REFERENCE TO RELATED APPLICATION

The present application claims priority to German Patent Application No. 10 2022 203 459.7 filed on Apr. 6, 2022. The entire contents of the above-listed application is hereby incorporated by reference for all purposes.

### BACKGROUND

The disclosure relates to an assembly of a vehicle according to the preamble of claim 1.

Such an assembly comprises a vehicle door, a control element arranged on a door portion of the vehicle door, the control element including an outer portion facing away from the door portion and an inner portion facing the door portion, and a control device for controlling a closing function for closing the vehicle door and an opening function for opening the vehicle door.

Such a vehicle door in particular can be a vehicle side door that is pivotally arranged on a vehicle body. The control device can be used for example to control a closing movement for closing the vehicle door and/or an opening movement for opening the vehicle door by actuating an electromotive door drive device, wherein the door drive device can be used for example to automatically adjust the vehicle door between particular positions or to electromotively support a manual adjustment of the vehicle door in a servo mode.

While in conventional vehicles a handle is provided on a vehicle door, which can be mechanically adjusted by a user, there is a trend in more recent vehicle doors to dispense with such an adjustable handle. For example, in the Ford Mustang Mach-E available at the filing date a stationary control element each is arranged on the front vehicle side doors, which can be touched by a user in order to operate the vehicle door. While in more recent vehicle concepts an operation of a vehicle door can also be possible by remote control or automatically on approach of an (authenticated) user, and thus does not necessarily require an operation via a control element on the vehicle door, such a control element nevertheless is to be provided on the vehicle door in order to allow third parties to have access to the vehicle for example in an emergency, such as in an accident of the vehicle.

To provide for an operation, a sensor system for example is provided on such a control element, in order to detect by means of sensors when a user touches the control element and to control an opening or closing movement in dependence on such a detection. Because such a control element can be of small design, little space is available, however, for control surfaces on the control element.

### SUMMARY

It is an object of the proposed solution to provide an assembly of a vehicle, in which an operation of a control element by a user is possible easily and intuitively.

This object is achieved by an assembly of a vehicle with the features of described herein.

Accordingly, the control element includes at least one first operating device for generating an operating signal on user operation at the outer portion and at least one second operating device for generating an operating signal on user operation at the inner portion. The control device is configured to trigger a closing function for closing the vehicle door with reference to an operating signal of the at least one first operating device and to trigger an opening function for opening the vehicle door with reference to an operating signal of the at least one second operating device.

The control element has different surface portions. A first, outer portion faces towards the outside. A second, inner portion on the other hand faces towards the inside. In the case of an intuitive operation of the control element it can be assumed that a user intuitively acts on the control element in such a direction that corresponds to the desired direction of movement of the vehicle door. When a user for example wants to close the vehicle door, he will act on the control element from outside, i.e. on the outwardly facing outer portion. On the other hand, when the user wants to open the vehicle door, he will act on the control element intuitively from inside, i.e. on the inwardly facing inner portion.

This finding here is made use of due to the fact that a first operating device for generating an operating signal on user operation is arranged on the outer portion, and a second operating device for generating an operating signal is arranged on the inner portion. When an operating signal generated by the first operating device is present, the control device evaluates the same and triggers a closing function for closing the vehicle door. On the other hand, when an operating signal generated by the second operating device is present, the control device triggers an opening function for opening the vehicle door. Thus, a closing function is triggered by operation on the outside of the control element, whereas an opening function is triggered by operation on the inside of the control element.

Preferably, all control surfaces for triggering a closing function are arranged on the outer portion and thus on the outside of the control element. All control surfaces for triggering an opening function on the other hand preferably are arranged on the inner portion and thus on the inside of the control element.

Thus, a user can effect closing of the vehicle door by touching the control element from outside. By touching the inside of the control element, on the other hand, an opening function is triggered for opening the vehicle door. The fact that the operation corresponds to the intuition of the user results in an operation comfortable for the user, while a risk for an incorrect operation is reduced at the same time.

In this connection, triggering refers to the fact that the control device generates a control signal and sends the same to a functional assembly, in particular an electromotive door drive for adjusting the vehicle door or an electric door lock, in order to start an adjusting operation by the functional assembly. The adjusting operation can additionally be controlled by the control device, for example for carrying out an automatic adjustment of the vehicle door between particular positions or for carrying out a servo adjustment.

In one embodiment, the control element can be arranged on the vehicle door as a mechanically adjustable handle. The control element can, however, also be stationarily arranged on the vehicle door or be rigidly connected to the door portion of the vehicle door.

In one embodiment, the triggering of the closing function comprises the controlling of a door drive for carrying out an automatic closing movement of the vehicle door, the controlling of a door drive for carrying out a servo-electrically supported closing movement of the vehicle door and/or the controlling of a door lock for locking the vehicle door in a closed position. In an automatic adjusting mode an electromotive door drive adjusts the vehicle door between predetermined positions, for example from the open position just taken into a completely closed position. In a servo-electrically supported closing movement, moving the vehicle door on the other hand is effected manually by a user, wherein the electromotive door drive preferably provides a supporting force in such a way that a user can apply a constant user force via the adjusting movement, but an additionally required adjusting force is provided by the door drive (such a servo mode is described for example in DE 10 2019 211 717 A1). By actuating an electric door lock on closing, the door lock can be transferred from an unlocked position into a locked position in order to complete the closing operation in this way.

In one embodiment, the triggering of the opening function comprises the controlling of the door drive for carrying out an automatic opening movement of the vehicle door, the controlling of the door drive for carrying out a servo-electrically supported opening movement of the vehicle door and/or the controlling of the door lock for unlocking the door lock and/or for opening the door lock. For opening, too, the vehicle door can automatically be adjusted between defined positions, for example between a completely closed position and an open position, by actuating the door drive. Moreover, an adjustment in the servo mode is possible by a user manually adjusting the vehicle door, but with an electromotive support by the door drive. Before the beginning of an opening movement, the door lock must be unlocked and opened by actuation, so that the vehicle door is released and can be moved out of its closed position.

When the door lock is locked, the door lock cannot be opened. The door lock can be unlocked in particular based on an authentication, so that the door lock can be opened. When the door lock is open, the vehicle door can be moved out of the closed position and can thus be opened.

The first operating device and/or the second operating device can each be formed by an arrangement of one or more sensors. It here is also conceivable and possible that the first operating device and the second operating device are formed by a common sensor, which however can detect an operation by a user at spatially different portions of the control element, in order to generate a corresponding operating signal. On operation by a user, i.e. when approached or touched by a user, the first operating device and/or the second operating device generate an operating signal that can be evaluated by the control device in order to obtain a spatial information on the operation and to correspondingly trigger a closing function or an opening function with reference to the spatial information of the operation.

The first operating device and/or the second operating device can, for example, include a proximity sensor for generating an operating signal on approach of an object, a touch sensor for generating an operating signal when touched by an object and/or a force sensor for generating an operating signal in dependence on a force exerted by an object. A proximity sensor can be realized for example by a capacitive sensor, by an optical sensor (by measuring the light intensity or by propagation time measurement), by an ultrasonic sensor or also by a radar sensor. A touch sensor can be realized for example by a capacitive sensor or for example also by a tip switch. A force sensor can be realized for example by an inductive sensor or piezoelectric sensor and outputs an operating signal, which in addition to the information on the presence of an operation also indicates information on a force exerted by the user during the operation.

An operating signal generated by a force sensor can serve for example for controlling a servo function for a servo-electrically supported adjustment in dependence on an applied user force.

Each operating device also can include different sensors, for example a proximity sensor and a touch sensor. Thus, first an approach and then a touch can be detected at the operating device. Alternatively or in addition to the proximity sensor or the touch sensor, a force sensor possibly can also be provided so that in the case of a touch a touch force can also be determined.

The first operating device and/or the second operating device (each) can realize several control surfaces on the associated portion of the control element. A separate sensor element here can be associated to each control surface. The control surfaces can, however, also be provided by a single sensor element, wherein via the sensor element an operation can be detected at different places and can be spatially differentiated.

In one embodiment, the at least one first operating device can be configured to generate a first operating signal in the case of a user operation on a first control surface on the outer portion and to generate a second operating signal in the case of a user operation on a second control surface on the outer portion. The control device is configured to trigger a first closing function in response to the first operating signal and a second closing function different from the first closing function in response to the second operating signal. By approaching or touching different control surfaces, a user thus can trigger different closing functions. By operation on a first control surface, an automatic closing of the vehicle door for example can be started, while by operation of a second control surface for example locking of the door lock or a closing movement up to a half-open position is triggered.

Analogously, in one embodiment, the at least one second operating device can be configured to generate a first operating signal in the case of a user operation on a first control surface at the inner portion and to generate a second operating signal in the case of a user operation on a second control surface at the inner portion. The control device is configured to trigger a first opening function in response to the first operating signal and a second opening function different from the first opening function in response to the second operating signal. For opening, a user thus can operate different control surfaces. When a user operation is effected on a first control surface, the control device triggers a first opening function. When a user operation on the other hand is effected on a second control surface, the control device triggers a second opening function. In this way, the user for example can start unlocking and opening of the door lock or an automatic opening movement of the vehicle door.

Because the surface size available for each control surface can be small when different control surfaces are provided on the outer portion and/or on the inner portion, it may be desirable to minimize the number of control surfaces on the different portions of the control element, in order to for example provide only one control surface on each of the outer portion and the inner portion, which can be operated by a user for generating an operating signal. In this way, the operating comfort can also be improved for a user, because a user can touch the respective portion in a simple, undifferentiated way in order to trigger an operation of the vehicle door.

To make the operation as intuitive and comfortable as possible for a user, it can be provided in one embodiment that the control device is configured to evaluate a functional state of the vehicle door, in particular a current position of the vehicle door and/or a position of a door lock, in addition to the operating signal of the respective operating device, for controlling the closing function and/or for controlling the opening function.

In particular, the control device can be configured to trigger a first closing function in response to an operating signal of the at least one first operating device in a first functional state of the vehicle door and to trigger a second closing function different from the first closing function in a second functional state of the vehicle door. Additionally or alternatively, the control device can be configured to trigger a first opening function in response to an operating signal of the at least one second operating device in a first functional state of the vehicle door and to trigger a second opening function different from the first opening function in a second functional state of the vehicle door.

When a closing function is triggered, it can be taken into account, for example, whether the vehicle door is in an open position or in the closed position. When the vehicle door is in an open position, it is not expedient to actuate the door lock as a closing function for locking purposes. In an automatic mode, for example, the vehicle door instead can be closed by an electric motor. When the vehicle door, on the other hand, is in the closed position, an electromotive adjustment of the vehicle door in the closing direction is not expedient. When an operation has been detected on the outer portion of the control element, the door lock instead can be actuated for example for locking the vehicle door. The control device thus queries a functional state and controls the closing function in dependence on the functional state.

When an opening function is triggered, it can be taken into account for example whether the vehicle door is in the closed position or in an open position. It can also be taken into account whether the door lock is in a locked or unlocked position. When the door lock for example is in the locked position, an operation on the inner portion of the control element can lead to a triggering of the unlocking and opening of the door lock. When the door lock, on the other hand, is already unlocked and open, an operation on the inner portion of the control element can lead to an opening of the vehicle door for example by automatic adjustment into an open position. The control device thus queries a functional state for opening and controls the opening function in dependence on the functional state.

It here is also conceivable and possible that, for example, when operating on the inner portion, an approach initially is detected via the first operating device (for example via a proximity sensor of the first operating device) and leads to an unlocking of the door lock. When a touch then is detected on the inner portion (for example via a touch sensor of the first operating device), this is evaluated by the control device, which thereupon triggers an opening movement, for example an automatic opening by actuation of the door drive.

The additional evaluation of the functional state of the vehicle door, in particular of the position of the vehicle door or the state of the door lock, can also be used for a plausibility check. It can occur that a user not only touches the inner portion or the outer portion, but encloses the control element and thus touches the control element on the inside and on the outside. When the vehicle door for example is closed and the door lock is locked and a user touches both the inner portion and the outer portion (for example because the user takes the control element into his hand so as to enclose the same), the evaluation of the functional state of the vehicle door allows to infer that the user probably desires an opening of the vehicle door, and correspondingly, the control device can actuate an opening function, for example an unlocking and/or opening of the door lock and an electromotive opening movement.

When the vehicle door, for example, is in a partly open position and it is detected that a user encloses the control element and thereby touches the inner portion and the outer portion at the same time, it can be inferred that a user desires an adjustment of the vehicle door, but no automatic adjusting movement. Correspondingly, a closing function or an opening function can be initiated for a servo-electrically supported adjustment of the vehicle door.

In addition or alternatively to the evaluation of the functional state of the vehicle door, an operating time and/or an operating pattern can also be evaluated by the control device with reference to the generated operating signal. The control device, for example, can be configured to evaluate an operating time and/or an operating pattern with reference to the operating signal of the at least one first operating device and to trigger a first closing function or a second closing function in dependence on the operating time and/or the operating pattern. In addition or alternatively, the control device can be configured to evaluate an operating time and/or an operating pattern with reference to the operating signal of the at least one second operating device and to trigger a first opening function or a second opening function in dependence on the operating time and/or the operating pattern.

With reference to the respective operating signal it is determined for example for which time period a user touches the outer portion or the inner portion. This time period, which corresponds to the operating time, can be determined for example with reference to a rising edge and a falling edge of an operating signal, for example on exceedance or falling below a signal threshold value. With reference to the operating time, it is possible for example to differentiate between an automatic adjusting mode and a servo mode. When the operating time for example is smaller than a predetermined threshold value (for example less than 1 s), it is inferred that a user desires an automatic adjustment of the vehicle door, and the control device correspondingly actuates the door drive for an automatic adjustment. When the operating time on the other hand exceeds the predetermined threshold value, it is assumed that a user desires a manual, guided adjustment of the vehicle door with an electromotive support in the servo mode, and the control device correspondingly actuates the door drive for a servo-electrically supported adjustment. In each case it is also possible for example to trigger an unlocking and opening of the door lock, when the vehicle door is in the closed position.

For an opening movement of the vehicle door, an opening operation of the door lock can be controlled with reference to the operating signal. With a rising edge of the operating signal the door lock can be opened so that an opening movement of the door lock is possible. When a user thereupon releases the control element, before the threshold value of the operating time is reached, the automatic adjustment of the vehicle door is initiated. When the user on the other hand leaves his hand on the control element, the user can manually adjust the vehicle door by electromotive support in the servo mode and thus can open the vehicle door in a manually guided way.

Additionally or alternatively, an operating pattern can be identified with reference to the operating signal. For example, a user can generate a particular operating gesture, for example a pulse sequence due to repeatedly tapping on the control element, which can be evaluated correspondingly by the control device and triggers a particular opening or closing function.

In one embodiment, the control element includes at least one third operating device for generating an operating signal on user operation at an end-face portion located between the outer portion and the inner portion. The control device is configured to trigger a communication mode for an authentication communication with an external authentication device with reference to an operating signal of the at least one third operating device.

This is based on the idea that before triggering in particular an opening function, the authentication of a user is to be checked. For a keyless access (so-called “keyless entry”), this can be effected in particular by initiating a communication between the control device and an external authentication device of the user, for example a radio key or a communication device such as a mobile phone or the like, during which the authentication of the user is detected. Such a communication can be initiated by detecting and evaluating an operation by a user at the control element. For this purpose, a third operating device can be provided, which is arranged on a portion of the control element different from the outer portion and the inner portion and detects when this further portion is touched by a user and correspondingly generates an operating signal.

The end-face portion, on which the third operating device is arranged, in particular can be arranged on a narrow end face pointing upwards (with respect to the vehicle vertical direction) or on a narrow end face of the control element pointing rearwards (with respect to the vehicle longitudinal direction).

The third operating device in particular can be formed by a proximity sensor for generating an operating signal on approach of an object.

For operating the second operating device on the inner portion of the control element, a user for example can reach behind the control element with his hand. In a natural sequence of movements, a user initially will pass an end face of the control element, which can be detected correspondingly by the third operating device, designed for example as a proximity sensor. Thus, the control device can start a communication for authenticating an external authentication device and unlock the door lock in the case of a successful authentication, and thus enable the operation for opening the vehicle door.

Due to the fact that the authentication communication can be triggered already due to the location of the third operating device on the control element, before a user grasps the inner portion of the control element, the authentication can be started early and preferably be completed already when a user grasps the inner portion of the control element for operation in order to trigger an opening function. This results in a comfortable operation for a user with no or a hardly perceptible delay due to the authentication.

The authentication communication in particular can comprise the search for a radio signal of an authenticated radio key. In connection with the authentication communication, the control device for example can emit a radio signal in order to trigger a response of a radio key. When a response is received properly, the radio key is accepted as authorized and the authentication correspondingly is completed.

### BRIEF DESCRIPTION OF THE DRAWINGS

The idea underlying the solution will be explained in detail below with reference to the embodiments illustrated in the Figures, in which:

FIG. 1 shows a schematic view of a vehicle with a vehicle door arranged thereon.

FIG. 2 shows a schematic view of a control element of the vehicle door.

FIG. 3 shows another view of the control element.

FIG. 4 shows a view of an outer portion of the control element.

FIG. 5 shows a view of an inner portion of the control element.

FIG. 6 shows another view of the control element.

### DETAILED DESCRIPTION

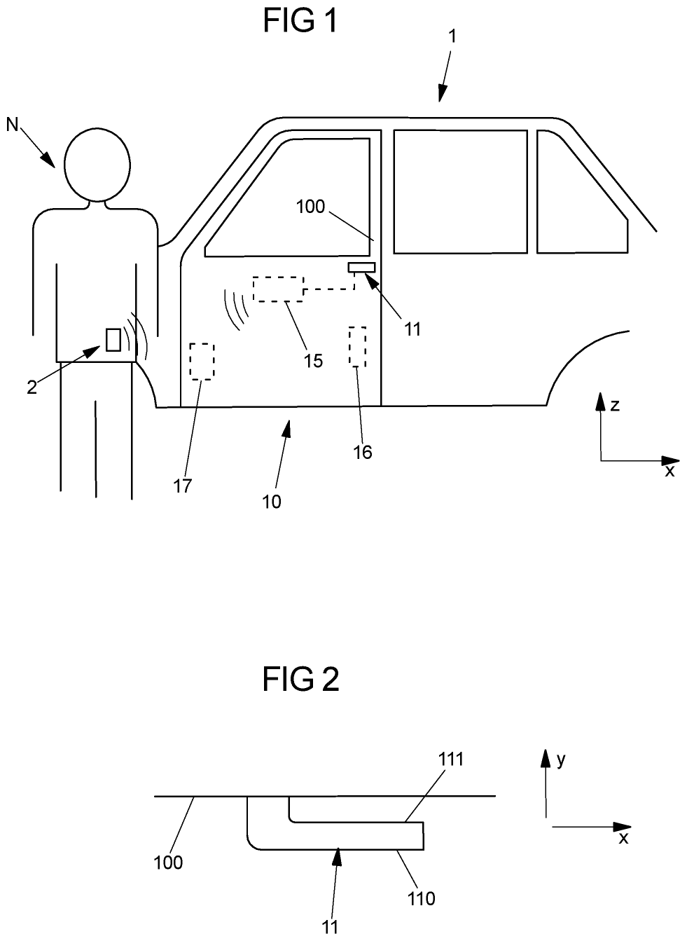

FIG. 1 shows a vehicle 1 that includes a vehicle door 10 in the form of a vehicle side door. The vehicle door 10 can be electromotively adjusted via an electromotive door drive 17. An electrically actuatable door lock 16 serves for locking the vehicle door 10 with the vehicle body of the vehicle 1 in a closed position.

The door drive 17 for example can be designed as it is described in WO 2021/023893 A1.

On the vehicle door 10 a control element 11 is arranged, which for example can be rigidly arranged on a door portion 100, for example in the region of the B-pillar of the vehicle 1. Such a control element 11, in contrast to a conventional handle element, is not mechanically adjustable, but is of rigid design and thus cannot be mechanically moved to the door portion 100.

A sensor system for operating the vehicle door 10, in particular for carrying out a closing function and for carrying out an opening function, is arranged on the control element 11.

A control device 15 serves for controlling closing functions and opening functions of the vehicle door 10 and therefor controls the door drive 17 and the electric door lock 16. The control device 15 also serves for evaluating operating signals that are obtained via the control element 11.

In particular, a communication with an external authentication device 2 of a user can also be effected via the control device 15, by which communication the user N is authenticated for an access to the vehicle 1. The external authentication device 2 of the user N can be designed, for example, by a radio key or a communication device such as a mobile phone or the like. When the user N approaches the vehicle, a communication with the control device 15 can be initiated, during which the control device 15 sends an authentication request to the external authentication device 2 and, if the response is positive, authenticates the user.

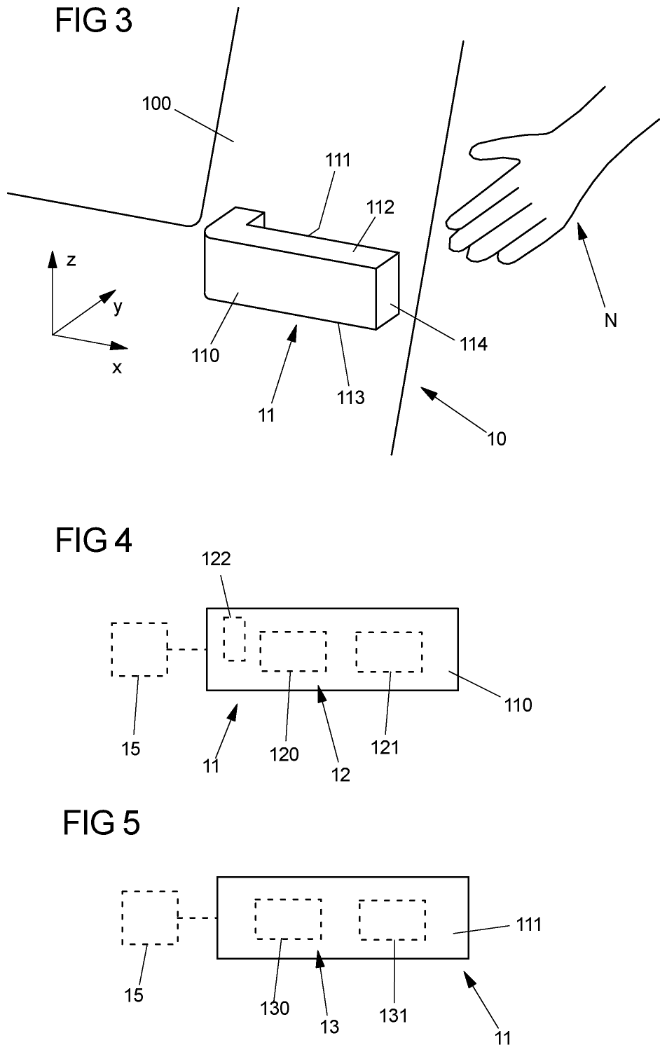

Different views of the control element 11 are shown in FIGS. 2-6. While in more recent vehicle concepts an access of a user N to the vehicle 1 can be possible in a keyless way by access being granted automatically, for example by automatically opening the vehicle door 10 on approach of a user N after successful authentication, a control element 11 is provided on the vehicle 1, for example to grant a third party access to the vehicle, for example in an emergency, or to create an operating possibility for a user for comfortable operation. The control element 11 provides for touching the vehicle door 11, wherein an operation is detected via a sensor system on the control element 11 and correspondingly an opening function or closing function of the vehicle door 10 can be triggered.

As this is shown in FIG. 2, the control element 11 in the illustrated embodiment is stationarily arranged on a door portion 100 of the vehicle door 10. The control element 11 can have a handle-like shape and forms an outwardly facing, outer portion 110 and an inner portion 111 facing inwards, towards the door portion 100, which are facing away from each other with respect to the vehicle transverse direction Y. The control element 11 also includes an upper (with respect to the vehicle vertical direction Z) end-face portion 112, a lower end-face portion 113 and a rearwardly facing (with respect to the vehicle longitudinal direction X) end-face portion 114, which each are arranged between the outer portion 110 and the inner portion 111, and thus form an edge-like narrow portion at the transition between the outer portion 110 and the inner portion 111.

The outer portion 110, the inner portion 111 and also the end-face portions 112-114 can be of flat design. The portions 110-114, however, can also be curved.

The control element 11 includes a first operating device 12, which detects operating signals via control surfaces 120, 121 on the outer portion 110 and forwards the same to the control device 15. The control element 11 also includes a second operating device 13, which detects operating signals via control surfaces 130, 131 on the inner portion 111 and forwards the same to the control device 15.

On the outer portion 110, there is also provided a communication interface 122 for communication with a communication device, for example an NFC interface for near field communication. Via the communication interface 122, for example, an operation can be effected via a communication device, for example a mobile phone, when another authentication device 2, for example a radio key, is not ready for operation, for example when the battery of the radio key is empty.

Each operating device 12, 13 can include one or more sensor elements. Each control surface 120, 121, 130, 131 can be formed by one sensor element each. It is also conceivable, however, that the control surfaces 120, 121, 130, 131 on the outer portion 110 and the inner portion 111, respectively, are formed by a common sensor element that can detect an operating signal in a spatially differentiated way.

The first operating device 12 and the second operating device 13 can, for example, each include a touch sensor, a proximity sensor or also a force sensor or a combination of different sensors. The sensors of the operating devices 12, 13 can be formed, for example, by capacitive sensors, inductive sensors, optical sensors (in particular infrared sensors), ultrasonic sensors, radar sensors, piezoelectric sensors or also mechanical tip switches.

When the respective operating device 12, 13 includes a force sensor, information on an exerted force can also be determined in addition to information on an approach or a touch. This information can be used for example for controlling a servo mode, for example to determine a force exerted by a user on the vehicle door 10 during a manual adjustment, and to use said force for controlling the door drive 17 for a servo-electrically supported adjustment or to avoid false triggering by means of a plausibility check.

Via the control surfaces 120, 121, 130, 131 it can be detected whether a user for example touches the control element 10 with his hand in order to perform an operation on the control element 10. Operating signals, which are detected via the control surfaces 120, 121 of the first operating device 12, here are evaluated by the control device 15 in order to trigger a closing function. Operating signals, which are detected via the control surfaces 130, 131 of the second operating device 13 on the inner portion 111 of the control element 11, on the other hand, are evaluated by the control device 15 in order to trigger an opening function of the vehicle door 10.

The fact that all closing functions of the vehicle door 10 are triggered on the outer portion 110, whereas all opening functions are triggered on the inner portion 111, results in an intuitive operation for the user N. Thus, the user N will intuitively approach his hand to the control element 11 from outside for closing the vehicle door 10. For opening, however, the user N will intuitively act on the control element 11 from inside, and thus will act on the inner portion 110. The fact that for triggering a closing function the control surfaces 120, 121 are arranged on the outer portion 110 of the control element 11, and for triggering an opening function the control surfaces 130, 131 are arranged on the inner portion 111 of the control element 11, results in a comfortable, intuitive operation for the user N, with the risk of maloperation being reduced at the same time.

On the outer portion 110 and the inner portion 111 one or more control surfaces 120, 121, 130, 131 can each be arranged. Via several control surfaces 120, 121, 130, 131 different functions can be triggered in a simple way. When only one control surface is provided on each portion 110, 111, a comfortable operation on the other hand is obtained for a user, because the user can touch a larger control surface without any major spatial differentiation.

A closing function can, for example, be an automatic adjustment of the vehicle door 11 into the closed position, driven by the door drive 17. A closing function can also be a servo-electrically supported adjustment or the locking of the vehicle door 10 by the door lock 16.

An opening function, on the other hand, can be realized by an unlocking of the door lock 16 by an automatic opening of the vehicle door 10, driven by the door drive 17, or by a servo-electrically supported opening of the vehicle door 10.

When a user N for example touches a first control surface 120 on the outer portion 110, this can trigger an automatic closing of the vehicle door 10 out of an open position. On the other hand, when the user N touches a second control surface 121, this can cause a servo mode for a servo-electrically supported adjustment of the vehicle door 10 out of the open position in the direction of the closed position. Further control surfaces can be provided for further closing functions.

On the other hand, when a user N touches a first control surface 130 on the inner portion 111, this can cause an unlocking and opening of the door lock 16, wherein in addition—in case an authentication of a user N has not yet been effected—the control device 15 can start a key search for authenticating an external authentication device 2 of a user N in order to perform an unlocking of the door lock 16 only after successful authentication. On the other hand, when the user N touches a second control surface 131, this can trigger automatic opening of the vehicle door 10 by controlling the door drive 17 or a servo-electrically supported opening of the vehicle door 10 in a servo mode. Further control surfaces can be provided for further opening functions.

To a control surface 130, via which an unlocking and opening of the door lock 16 is triggered, an inductive sensor can be associated, for example, which provides for an operation for example in an emergency also under water.

In particular to provide for an operation over a minimized number of control surfaces 120, 121, 130, 131, preferably only one control surface each on the inner portion 111 and the outer portion 110, further parameters for controlling a closing function or an opening function can be taken into account in addition to an operating signal generated by the respective operating device 12, 13. For example, the control device 15 can evaluate a functional state of the vehicle door 10, for example the position of the vehicle door 10 or a state of the door lock 16. This provides for combining control surfaces on the outer portion 110 or the inner portion 111 so that a triggering of a closing function or an opening function is effected on operation of a control surface and additionally in dependence on a functional state of the vehicle door 10.

When the vehicle door 10 is in an open position and a user N touches a control surface 120, 121 on the outer portion 110, it can be provided that an adjusting movement is initiated for closing the vehicle door 10, for example an automatic closing or closing in the servo mode, but not a controlling of the door lock 16 for locking purposes.

When the vehicle door 10 is in the closed position and a user N touches a control surface 130, 131 on the inner portion 111, the control device 15 initially can trigger an unlocking and opening of the door lock 16. When the operating device 13 includes different sensors, for example a proximity sensor and a touch sensor, it can also be provided in this connection that on detection of an approach to the inner portion 111, the door lock 16 initially is unlocked (and possibly—in case an authentication of the user N has not yet been effected—a key search for authenticating an external authentication device 2 of a user N is started in advance in order to unlock the door lock 16 only upon successful authentication) and then, on detection of a touch of the inner portion 111, an adjusting movement of the vehicle door 10 is triggered for opening purposes.

In addition or as an alternative to the evaluation of a functional state of the vehicle door 10 a type of operation, for example an operating time or an operating pattern can also be evaluated.

With reference to an operating signal generated by the respective operating device 12, 13, the control device 15 can determine an operating time for which a user actuates the control element 11. The operating time can be determined, for example, as a time period of a high signal in the case of a touch sensor or a proximity sensor and can be measured with reference to a rising edge and a falling edge. When it is detected that a user only briefly taps on the control element 11 on the outer portion 110 or the inner portion 111, this can indicate that an automatic adjustment is to be triggered, and the control device 15 correspondingly can control the door drive 17. On the other hand, when a user N touches the control element 11 for a long time, this can indicate that a user wants to manually adjust the vehicle door 10 in a guided way in the servo mode so that the servo mode can be started by controlling the door drive 17.

For differentiating between the automatic adjusting mode and the servo mode, the operating time for example can be compared with a threshold value, wherein at an operating time that is smaller than the threshold value the automatic adjusting mode is started, and at an operating time that is greater than the threshold value the servo mode is started.

An operating pattern can be, for example, a particular type of operation, for example a particular pulse sequence with which a user taps on the control element 11, or a predetermined operating gesture that can be identified correspondingly by the control device 15 with reference to the generated operating signal of the respective operating device 12, 13. With reference to a particular operating pattern, a predetermined opening function or closing function can be triggered.

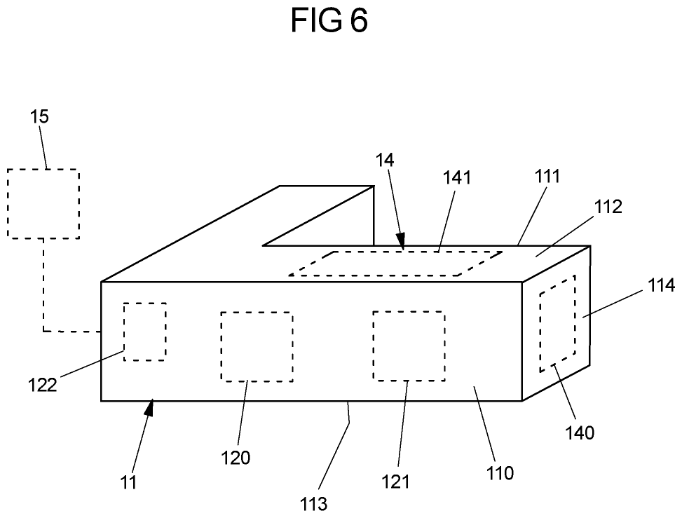

In the illustrated embodiment, as this is shown in FIG. 6, control surfaces 140, 141 of a further operating device 14 can be arranged on the end-face portions 112, 113, 114. Via the control surfaces 140, 141 it can be detected in particular that a user N for example approaches the inner portion 111 with his hand and thus (probably) wants to trigger an opening function.

The operating device 14 preferably includes one or more proximity sensors. Via the operating device 14 it can thus be determined whether a user N approaches one of the end-face portions 112, 114 with his hand.

Via the operating device 14 in particular an operating signal can be generated, which is evaluated by the control device 15 and leads to the triggering of an authentication communication with the external authentication device 2 of the user N. When the control device 15 detects that a user N approaches the inner portion 111 of the control element 11 and in doing so passes one of the end-face portions 112, 114 (which is detected by a proximity sensor of the operating device 14), the control device 15 starts a communication with the external authentication device 2, during which the authentication of the external authentication device 2 is queried. When the authentication is successful, the user N can trigger an opening function by operation at the inner portion 111, for example for unlocking and/or opening the door lock 16.

Due to the fact that the end-face portions 112, 114 are arranged at the transition between the outer portion 110 and the inner portion 111 on the narrow sides of the control element 11, a user N must pass the end-face portions 112, 114 when approaching the inner portion 111 due to the location of said end-face portions. Due to the sensory operating device 14 at these end-face portions 112, 114, an approach to the inner portion 111 can thus be detected at an early stage so that an authentication communication can be started at an early stage. The authentication of the user N can thus be started at an early stage so that, when an operation is effected at the inner portion 111, the authentication of the user N preferably is already completed. The authentication thus is triggered by approaching the control element 11 and can be performed prior to operation at the inner portion 111 so that a time delay due to the required authentication prior to operation at the inner portion 111 is not or at least only hardly perceptible for a user N.

An authentication communication also can be started when a user N touches the outer portion 110 or the inner portion 111, without an authentication having already been effected. Thus, during the operation on a control surface 120, 121, 130, 131 at the outer portion 110 or the inner portion 111, if no authentication has yet been effected, an authentication first is carried out.

The idea underlying the solution is not limited to the embodiments described above, but can also be realized in a different way.

The vehicle door can be formed by a vehicle side door or by a liftgate.

Different closing functions and opening functions can be performed on a vehicle door, wherein not all of the closing functions or opening functions described here have to be present. Moreover, further or other closing functions or opening functions, for example for moving a window pane or the like, can also be provided.

1. An assembly of a vehicle, comprising
a vehicle door,
a control element arranged on a door portion of the vehicle door, the control element including an outer portion facing away from the door portion and an inner portion facing the door portion, and
a control device for controlling a closing function for closing the vehicle door and an opening function for opening the vehicle door,
wherein the control element includes at least one first operating device for generating an operating signal on user operation at the outer portion and at least one second operating device for generating an operating signal on user operation at the inner portion, and
wherein the control device is configured to trigger a closing function for closing the vehicle door with reference to an operating signal of the at least one first operating device and to trigger an opening function for opening the vehicle door with reference to an operating signal of the at least one second operating device.

2. The assembly according to claim 1, wherein the control element is rigidly arranged on the door portion

3. The assembly according to claim 1, wherein the triggering of the closing function comprises: controlling a door drive for carrying out an automatic closing movement of the vehicle door, controlling a door drive for carrying out a servo-electrically supported closing movement of the vehicle door and/or controlling a door lock for locking the vehicle door in a closed position.

4. The assembly according to claim 1, wherein the triggering of the opening function comprises: controlling a door drive for carrying out an automatic opening movement of the vehicle door, controlling a door drive for carrying out a servo-electrically supported opening movement of the vehicle door and/or controlling a door lock for unlocking the door lock and/or for opening the door lock.

5. The assembly according to claim 1, wherein the at least one first operating device and/or the at least one second operating device include a proximity sensor for generating an operating signal on approach of an object, a touch sensor for generating an operating signal when touched by an object and/or a force sensor for generating an operating signal in dependence on a force exerted by an object.

6. The assembly according to claim 1, wherein the at least one first operating device and/or the at least one second operating device include a capacitive sensor, an inductive sensor, a radar sensor, an optical sensor, an ultrasonic sensor and/or a piezoelectric sensor.

7. The assembly according to claim 1, wherein the at least one first operating device is configured to generate a first operating signal on user operation on a first control surface at the outer portion and to generate a second operating signal on user operation on a second control surface at the outer portion, wherein the control device is configured to trigger a first closing function in response to the first operating signal and to trigger a second closing function different from the first closing function in response to the second operating signal.

8. The assembly according to claim 1, wherein the at least one second operating device is configured to generate a first operating signal on user operation on a first control surface at the inner portion and to generate a second operating signal on user operation on a second control surface at the inner portion, wherein the control device is configured to trigger a first opening function in response to the first operating signal and to trigger a second opening function different from the first opening function in response to the second operating signal.

9. The assembly according to claim 1, wherein for controlling the closing function and/or for controlling the opening function the control device is configured to evaluate a functional state of the vehicle door, including a current position of the vehicle door and/or a position of a door lock, in addition to the operating signal of the at least one first operating device and/or the at least one second operating device.

10. The assembly according to claim 1, wherein the control device is configured
to trigger a first closing function in response to an operating signal of the at least one first operating device in a first functional state of the vehicle door and to trigger a second closing function different from the first closing function in a second functional state of the vehicle door, and/or
to trigger a first opening function in response to an operating signal of the at least one second operating device in a first functional state of the vehicle door and to trigger a second opening function different from the first opening function in a second functional state of the vehicle door.

11. The assembly according to claim 1, wherein the control device is configured
to evaluate an operating time and/or an operating pattern with reference to the operating signal of the at least one first operating device and to trigger a first closing function or a second closing function in dependence on the operating time and/or the operating pattern, and/or
to evaluate an operating time and/or an operating pattern with reference to the operating signal of the at least one second operating device and to trigger a first opening function or a second opening function in dependence on the operating time and/or the operating pattern.

12. The assembly according to claim 11, wherein the control device is configured to compare the operating time with a threshold value.

13. The assembly according to claim 1, wherein the control element includes at least one third operating device for generating an operating signal on user operation at an end-face portion located between the outer portion and the inner portion, wherein the control device is configured to trigger a communication mode for an authentication communication with an external authentication device with reference to an operating signal of the at least one third operating device.

14. The assembly according to claim 13, wherein the end-face portion, with respect to the vehicle vertical direction, faces upwards or, with respect to the vehicle longitudinal direction, faces rearwards.

15. The assembly according to claim 13, wherein the at least one third operating device comprises a proximity sensor for generating an operating signal on approach of an object.
